(19) United States
(12) Patent Application Publication
(10) Pub. No.: US 2007/0053345 A1
(43) Pub. Date: Mar. 8, 2007

(54) DATA TRANSMISSION SYSTEM

(76) Inventors: Po-Sheng Hsu, Taipei Hsien (TW); Chih-Yen Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,959

(22) Filed: Mar. 1, 2006

(30) Foreign Application Priority Data
Sep. 7, 2005 (TW) 094130757

(51) Int. Cl. H04L 12/66

(52) U.S. Cl. 370/352

(57) ABSTRACT

A data transmission system includes a data transmitting device coupled to the Internet for transmitting a broadcast packet containing identification data of the data transmitting device to the Internet; and a remote storage device coupled to the Internet for receiving the broadcast packet and determining if the identification data is valid; wherein when the identification data is determined to be valid, the remote storage device establishes a connection to the data transmitting device so that the data transmitting device transmits data to the remote storage device through the connection.

### BACKGROUND OF THE INVENTION

1. Field of the Invention

The present invention relates to data transmission techniques, and more particularly, to a data transmission system that transmits data by utilizing the Internet as a transmission medium.

2. Description of the Prior Art

Digital still cameras (DSC) and digital video recorders (DV) are very popular consumer electronics devices. For example, consumers usually utilize the digital camera or digital video to capture pictures or record video contents when they are traveling, attending a wedding, or other occasions.

However, the storage capacity of the storage medium (e.g., a memory card) installed within the DSC or DV is limited. If the user of the device wishes to shoot more pictures or additional video content, then one conventional approach is to use a storage medium having huge storage capacity or for the user to carry multiple storage media on his person for replacement (i.e., swapping) as each of the storage media's capacity is exhausted. Obviously, this solution is costly.

Another conventional approach is to connect the DSC or DV to a host device (e.g., a desktop computer, a laptop computer, or other storage apparatuses) when the memory space is fully utilized. The user can download image files having been recorded and saved in the storage medium of the DSC or DV to the host device and then deletes those image files from the storage medium in order to reuse the storage medium to store other pictures or video content. Unfortunately, the user needs to get a host device mentioned above to offload image files from the storage medium when the memory space of the storage medium runs out. It is inconvenient to carry a host device such as a laptop computer on one's person for storing the image files created by the DSC or DV, especially when the user participates in outdoor activities.

### SUMMARY OF THE INVENTION

It is therefore an objective of the claimed invention to provide data transmission systems to solve the above-mentioned problems.

According to an exemplary embodiment, a digital multimedia data transmission system is disclosed comprising: a digital multimedia data source for providing a digital multimedia data; a portable device coupled the digital multimedia data source for transmitting to the Internet utilizing a wireless transmission means a broadcast packet containing identification data of the portable device; and a remote storage device coupled to the Internet for receiving the broadcast packet and determining if the identification data is valid; wherein when the identification data is determined to be valid, the remote storage device establishes a connection to the portable device so that the portable device transmits the digital multimedia data to the remote storage device through the connection.

According to an exemplary embodiment, a data transmission system is disclosed comprising: a data transmitting device coupled to the Internet for transmitting to the Internet a broadcast packet containing identification data of the data transmitting device; and a remote storage device coupled to the Internet for receiving the broadcast packet and determining if the identification data is valid; wherein when the identification data is determined to be valid, the remote storage device establishes a connection to the data transmitting device so that the data transmitting device transmits data to the remote storage device through the connection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data transmission system according to an exemplary embodiment of the present invention.

FIG. 2 is a flowchart illustrating an embodiment for establishing a connection between a portable device and a remote storage device of FIG. 1.

### DETAILED DESCRIPTION

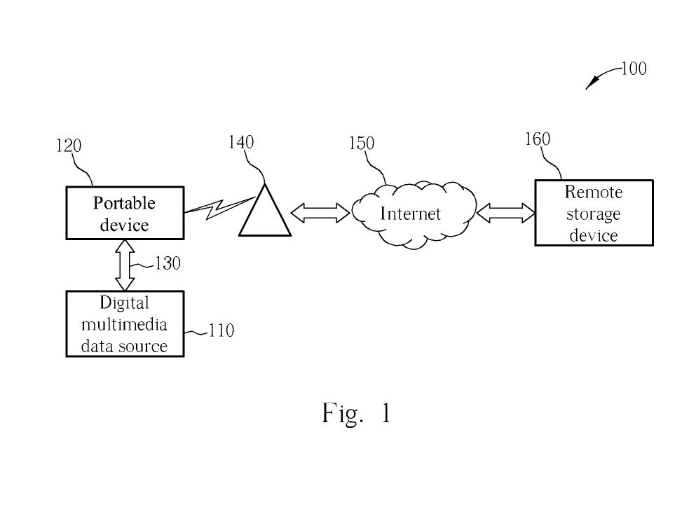

Please refer to FIG. 1, which shows a block diagram of a data transmission system 100 according to an exemplary embodiment of the present invention. As shown in FIG. 1, the data transmission system 100 comprises a digital multimedia data source 110; a portable device 120 coupled to the digital multimedia data source 110 through a transmission interface 130; and a remote storage device 160 coupled to the Internet 150. The digital multimedia data source 110 is utilized for providing a digital multimedia data such as image data, audio data, etc. The portable device 120 is a wireless networking device, which is capable of accessing the Internet 150 through an access point 140 utilizing a wireless transmission means. The remote storage device 160 may couple to the Internet 150 through various wired networking or wireless networking approaches.

In practice, the digital multimedia data source 110 may be a digital still camera (DSC), a digital video (DV), a digital voice recorder, a FLASH drive, etc. The portable device 120 may be a mobile phone or a PDA. The transmission interface 130 used for interconnecting the digital multimedia data source 110 and the portable device 120 may be a USB interface, an IEEE 1394 interface, a blue tooth transmission interface, or an IEEE 802.11 series interface. In general, when the digital multimedia data source 110 is coupled to the portable device 120 through the transmission interface 130, the digital multimedia data source 110 is regarded as a removable disk drive by the portable device 120.

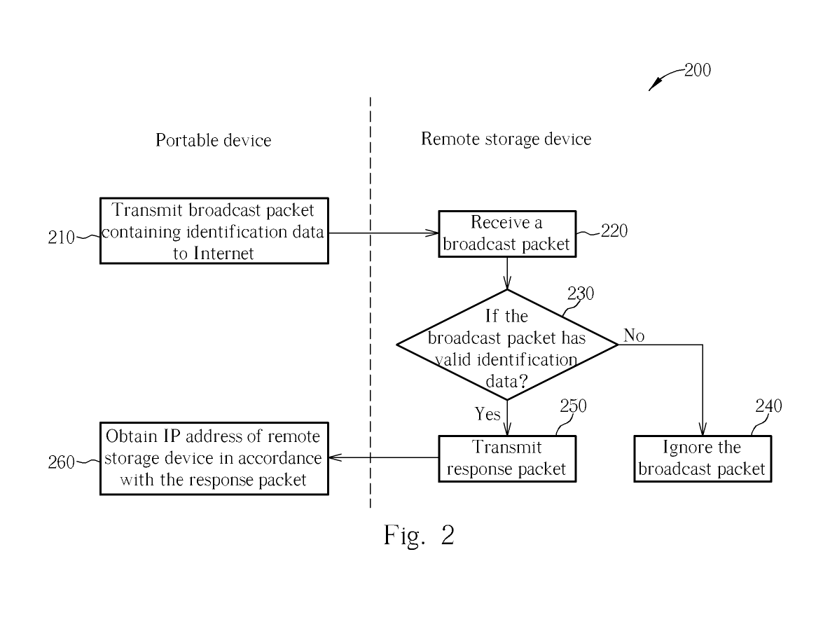

In the data transmission system 100, the portable device 120 retrieves the digital multimedia data provided from the digital multimedia data source 110 through the transmission interface 130, and transmits the digital multimedia data to the remote storage device 160 for storage via the Internet 150. In one aspect, the data transmission system 100 functions as a digital multimedia data transmission system in which the portable device 120 functions as a data transmitting device. Generally, when the remote storage device 160 utilizes an ADSL or other wide bandwidth networking means for access to the Internet 150, the IP address of the remote storage device 160 is assigned by the ISP (Internet Service Provider) and this IP address may be not be a fixed address. In addition, when the portable device 120 accesses the Internet 150 by utilizing a wireless transmission means, the IP address assigned for the portable device 120 is determined by the wireless area network at which the portable device 120 is presently located. In this embodiment, for example, the IP address of the portable device 120 is assigned by the access point 140. Therefore, the portable device 120 and the remote storage device 160 need to obtain the IP address of each other before the data transmission begins. Hereinafter, the data transmission between the portable device 120 and the remote storage device 160 will be explained with reference to FIG. 2.

FIG. 2 depicts a flowchart 200 illustrating an embodiment for establishing a connection between the portable device 120 and the remote storage device 160. The left half of the flowchart 200 shows operations of the portable device 120 and the right half of the flowchart 200 shows operations of the remote storage device 160.

In step 210, the portable device 120 transmits a broadcast packet containing identification data of the portable device 120 to the Internet 150 utilizing a wireless transmission means complying with a WLAN communication protocol. Specifically, the broadcast packet is transmitted to the Internet 150 through the access point 140. The identification data recorded in the broadcast packet may be unique information of the portable device 120, such as the device ID of the portable device 120. If the portable device 120 is a mobile phone, the identification data may be the SIM (subscriber identity module) number or the phone number thereof.

In step 220, the remote storage device 160 receives a broadcast packet from the Internet 150. In general, except the broadcast packet issued from the portable device 120 in step 210, there are many different broadcast packets existing on the Internet 150. Accordingly, when the remote storage device 160 receives a broadcast packet, it performs step 230 to check the broadcast packet.

In step 230, the remote storage device 160 examines if the received broadcast packet contains the identification data of the portable device 120. In practice, a predetermined program may be pre-installed in the remote storage device 160 and the identification data of the portable device 120 is registered at the predetermined program. As a result, when the remote storage device 160 receives a broadcast packet, it can execute the predetermined program to determine if the received broadcast packet contains a valid identification data of the portable device 120.

If the broadcast packet received by the remote storage device 160 in step 220 contains no identification data matching the identification data registered at the predetermined program, then the remote storage device 160 determines that the received broadcast packet is not transmitted form the portable device 120. Thus, the remote storage device 160 ignores the received broadcast packet in step 240. On the contrary, if the broadcast packet received by the remote storage device 160 in step 220 contains the identification data registered at the predetermined program, i.e., the identification data contained in the received broadcast packet is valid, then the remote storage device 160 determines that the received broadcast packet is transmitted from the portable device 120. Subsequently, the remote storage device 160 retrieves the current IP address of the portable device 120 from the received broadcast packet and performs step 250.

In step 250, the remote storage device 160 transmits a response packet to the portable device 120. According to the TCP/IP communication protocol, the current IP address of the remote storage device 160 is contained in the response packet.

Then, in step 260, the portable device 120 receives the response packet transmitted from the remote storage device 160 through the access point 140 and obtains the IP address of the remote storage device 160 in accordance with the response packet.

By the foregoing steps, the portable device 120 and the remote storage device 160 obtain the IP address of each other and a connection between the portable device 120 and the remote storage device 160 is established. Subsequently, the portable device 120 transmits the digital multimedia data provided by the digital multimedia data source 110 to the remote storage device 160 for storage through the connection. In practice, the remote storage device 160 may be a personal computer, a web server, or a portable device (e.g., a mobile phone or a PDA). In a preferred embodiment, after the connection between the portable device 120 and the remote storage device 160 is established, the portable device 120 automatically synchronizes data stored in the remote storage device 160 and the digital multimedia data source 110. For example, the portable device 120 can compare the data stored in the digital multimedia data source 110 with data stored in the remote storage device 160 and then the portable device 120 transmits only the data that is not present in the storage device 160. As a result, the remote storage device 160 will not miss or otherwise lack data nor will it receive redundant data from the portable device 120. By way of example, the digital multimedia data source 110 or the portable device 120 may be provided with a specific function key allowing the user to start the data transmission operations described previously by pressing the function key. In practice, the operations of comparing the data stored in the digital multimedia data source 110 with data stored in the remote storage device 160 may be instead performed by the remote storage device 160.

After the digital multimedia data is transmitted from the portable device 120 to the remote storage device 160, the user can clear the memory space of the digital multimedia data source 110 to facilitate the recording of other data.

According to the foregoing descriptions of the data transmission system 100, it can be appreciated that the user can easily backup data stored in a digital multimedia data source, such as a DSC or DV, to a remote storage device by utilizing a portable device that can be utilized as a wireless networking device. As a result, the user is not necessarily required to purchase a storage medium having a huge storage capacity or required to find (or carry) a storage device for storing backup files generated by the digital multimedia data source due to the memory space of the digital multimedia data source being reusable. In practical applications, a specific control key may be configured on the portable device 120 so that the user can press the control key to enable the portable device 120 to perform the above-mentioned operations. Additionally, the functionalities of the portable device 120 and the digital multimedia data source 110 may be integrated within a single electronic device, such as a mobile phone or PDA capable of taking pictures or recording video content.

In the disclosed architecture of the data transmission system 100, the portable device 120 utilizes the wireless networking approach to establish a connection to the remote storage device 160 and to transmit data to the remote storage device 160. This is merely a preferred embodiment rather than a restriction of the practical implementations. For example, the portable device 120 of the data transmission system 100 may be replaced by any other data transmitting device that is coupled to the Internet 150 through a wired configuration. Similarly, the data transmitting device can establish a connection to the remote storage device 160 and transmit data to the remote storage device 160 according to the method illustrated in the flowchart 200.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital multimedia data transmission system comprising:
a digital multimedia data source for providing a digital multimedia data;
a portable device coupled the digital multimedia data source for transmitting a broadcast packet containing identification data of the portable device to the Internet utilizing a wireless transmission means; and
a remote storage device coupled to the Internet for receiving the broadcast packet and determining if the identification data is valid;
wherein when the identification data is determined to be valid, the remote storage device establishes a connection to the portable device so that the portable device transmits the digital multimedia data to the remote storage device through the connection.

2. The digital multimedia data transmission system of claim 1, wherein the portable device is coupled to the digital multimedia data source through a USB interface, an IEEE 1394 interface, a blue tooth transmission interface, or an IEEE 802.11 series interface.

3. The digital multimedia data transmission system of claim 1, wherein the digital multimedia data source is a digital still camera (DSC), a digital video (DV), a digital voice recorder, or a FLASH drive.

4. The digital multimedia data transmission system of claim 1, wherein the portable device is a mobile phone or a PDA.

5. The digital multimedia data transmission system of claim 1, wherein the remote storage device is a personal computer, a web server, or a portable device.

6. The digital multimedia data transmission system of claim 1, wherein the wireless transmission means complies with a WLAN communication protocol.

7. The digital multimedia data transmission system of claim 1, wherein when the identification data of the broadcast packet is determined to be valid, the remote storage device transmits a response packet to the portable device so that the portable device obtains an IP address of the remote storage device in accordance with the response packet.

8. A data transmission system comprising:
a data transmitting device coupled to the Internet for transmitting a broadcast packet containing identification data of the data transmitting device to the Internet; and
a remote storage device coupled to the Internet for receiving the broadcast packet and determining if the identification data is valid;
wherein when the identification data is determined to be valid, the remote storage device establishes a connection to the data transmitting device so that the data transmitting device transmits data to the remote storage device through the connection.

9. The data transmission system of claim 8, wherein the data transmitting device is a portable device.

10. The data transmission system of claim 9, wherein the portable device transmits the broadcast packet to the Internet utilizing a wireless transmission means.

11. The data transmission system of claim 10, wherein the wireless transmission means complies with a WLAN communication protocol.

12. The data transmission system of claim 9, wherein the portable device is a mobile phone or a PDA.

13. The data transmission system of claim 8, further comprising:
a digital multimedia data source coupled to the data transmitting device for providing a digital multimedia data;
wherein the data transmitting device transmits the digital multimedia data to the remote storage device through the connection.

14. The data transmission system of claim 13, wherein the data transmitting device receives the digital multimedia data from the digital multimedia data source through a transmission interface.

15. The data transmission system of claim 14, wherein the transmission interface is a USB interface, an IEEE 1394 interface, a blue tooth transmission interface, or an IEEE 802.11 series interface.

16. The data transmission system of claim 13, wherein the digital multimedia data source is a digital still camera (DSC), a digital video (DV), a digital voice recorder, or a FLASH drive.

17. The data transmission system of claim 13, wherein the data transmitting device synchronizes data stored in the remote storage device and the digital multimedia data source.

18. The data transmission system of claim 13, wherein the remote storage device synchronizes data stored in the digital multimedia data source through the data transmitting device.

19. The data transmission system of claim 8, wherein the remote storage device is a personal computer, a web server, or a portable device.

20. The data transmission system of claim 8, wherein when the identification data of the broadcast packet is determined to be valid, the remote storage device transmits a response packet to the data transmitting device so that the data transmitting device obtains an IP address of the remote storage device in accordance with the response packet.
